(19) United States
(12) Patent Application Publication
(10) Pub. No.: US 2006/0067539 A1
(43) Pub. Date: Mar. 30, 2006

(54) Speaker system for vehicle

(75) Inventors: Koji Maekawa, Tendo-shi (JP); Katsuhiro Sasaki, Tendo-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/154,946

(22) Filed: Jun. 17, 2005

(30) Foreign Application Priority Data
Jun. 18, 2004 (JP) P2004-180938

(51) Int. Cl. H04B 1/00; H04R 5/02

(52) U.S. Cl. 381/86; 381/302; 381/389

(57) ABSTRACT

A speaker system for a vehicle including: a plurality of speaker units which are formed by attaching a speaker to an enclosure and located inside the vehicle, wherein an imaginary sound source is considered in arranging the speaker units inside the vehicle and the minimum resonance frequency of the speaker units is reduced.

### BACKGROUND OF THE INVENTION

1. Field of the Invention

The present invention relates to a speaker system for vehicle equipped inside a vehicle such as a passenger car.

2. Related Art

In a conventional technique, a speaker for vehicle which is equipped inside a vehicle such as a passenger car is ordinarily attached to a door for getting on and off.

Further, in order to reproduce a sound of high quality, an influence of the shape, structure or the like of an acoustic space is not negligible. Especially, vehicles have narrow inner spaces and a degree of freedom in equipping speakers is limited. Therefore, it cannot be a good acoustic space. Further, in order to reproduce an originally intended sound in vehicle, it is necessary to exercise ingenuity of effectively absorbing vibration from the speaker.

Further, a full range speaker is used as a speaker to be equipped in a passenger car. However, a low tessitura having a sufficient sound pressure cannot be reproduced with only a full range speaker.

Ordinarily, it is known that the diameter of a diaphragm should be increased for reproducing a low tessitura with a sufficient sound pressure, and the mass of the diaphragm should be increased. Further, as for reproduction in a high tessitura, it is unnecessary to increase the diameter of diaphragm and rather preferable to reduce the diameter in view of directivity.

A conventional speaker system used in a passenger motor car is disclosed in, for example, Japanese Unexamined Patent Publication Nos. JP-A-9-175282 and JP-A-9-328043.

However, when a speaker is attached to a door forgetting on and off a vehicle, a magnetic circuit vibrates by a counter action caused by an inner pressure or a vibrating system of an attach panel of the door. The vibration of the magnetic circuit is transmitted through a frame and effects on the attach panel to radiate a sound. Therefore, there is a disadvantage that a distorted sound and a delayed sound are generated to cause excessive echo. In order to solve this disadvantage, it is necessary to attach a vibration insulation material to the inside of the panel, and therefore a labor, a cost and so on are burdensome in installing the speaker.

Further, a high quality sound is obtainable by separately providing a woofer for reproducing a low sound range from the full range speaker. However, there are problems such that an additional cost is incurred and a space for installing the speaker is sometimes hard to prepare in dependence upon models and types of the vehicle.

### SUMMARY OF THE INVENTION

It is therefore an object of the present invention to solve the above-mentioned problems as one of the examples and to provide a speaker system that is equipped inside the vehicle and can easily reproduce a high quality sound.

The above object of the present invention can be achieved by providing a plurality of speaker units inside the vehicle in consideration of an imaginary sound source so as to lower the minimum resonance frequency.

According to a first aspect of the invention, there is provided a speaker system for a vehicle comprising:
a plurality of speaker units which are formed by attaching a speaker to an enclosure and located inside the vehicle, wherein
an imaginary sound source is considered in arranging the speaker units inside the vehicle and the minimum resonance frequency of the speaker units is reduced.

According to a second aspect of the invention, there is provided the speaker system according to the preceding claims, wherein
the minimum resonance frequency of the speaker unit is 200 Hz or less,
the speaker unit is located at the height 20 cm or less from the floor surface inside the vehicle, and
the inner capacity of the enclosure is 1000 cc or less.

According to a third aspect of the invention, there is provided the speaker system according to the preceding claims, wherein
a signal of a predetermined frequency or less is inputted into all of the speakers.

According to a fourth aspect of the invention, there is provided the speaker system according to the preceding claims, wherein
a signal of a predetermined frequency or less is inputted into all of the speakers.

According to a fifth aspect of the invention, there is provided the speaker system according to the preceding claims, wherein
the speaker unit mechanically reproduces a predetermined frequency or less.

According to a sixth aspect of the invention, there is provided the speaker system according to the preceding claims, wherein
the speaker unit mechanically reproduces a predetermined frequency or less.

According to a seventh aspect of the invention, there is provided the speaker system according to the preceding claims, wherein
the enclosure is of any one of a sealed type, a sealed type of allowing minute air leakage, a damped bass-reflex alignment type in which an acoustic material is assembled inside a port, and a band pass type.

According to an eighth aspect of the invention, there is provided the speaker system according to the preceding claims, wherein
the enclosure is of any one of a sealed type, a sealed type of allowing minute air leakage, a damped bass-reflex alignment type in which an acoustic material is assembled inside a port, and a band pass type.

According to a ninth aspect of the invention, there is provided the speaker system according to the preceding claims, wherein
a signal adjusted to match arrival times respectively from the speakers to an audience position is inputted into all the speakers.

According to a tenth aspect of the invention, there is provided the speaker system according to the preceding claims, wherein
a signal adjusted to match arrival times respectively from the speakers to an audience position is inputted into all the speakers.

According to an eleventh aspect of the invention, there is provided the speaker system according to the preceding claims, further comprising:
an arrival time adjusting means for electrically adjusting the arrival times respectively from the speakers to the audience position.

According to a twelfth aspect of the invention, there is provided the speaker system according to the preceding claims, further comprising:
an arrival time adjusting means for electrically adjusting the arrival times respectively from the speakers to the audience position.

According to a thirteenth aspect of the invention, there is provided the speaker system according to the preceding claims, wherein
a signal of a sub woofer in a 5.1 ch surround sound system is inputted to all the speakers.

According to a fourteenth aspect of the invention, there is provided the speaker system according to the preceding claims, wherein
a signal of a sub woofer in a 5.1 ch surround sound system is inputted to all the speakers.

### BRIEF DESCRIPTION OF THE DRAWINGS

In the accompanying drawings:

FIG. 1A shows a structure of a speaker unit according to a first embodiment;

FIG. 1B shows a structure of the speaker unit according to a second embodiment;

FIG. 2 illustrates a principle of mirror image;

FIG. 3A shows an example of installing a speaker unit according to the first embodiment; and

FIG. 3B shows an example of installing the speaker unit according to the second embodiment.

### DESCRIPTION OF THE PREFERRED EMBODIMENTS

Preferred embodiments of the present invention will be described in conjunction with figures. Hereinafter, each meaning of the reference numbers in the drawings is as follows: 2:enclosure, 3:speaker, and 10:speaker unit.

The embodiment will be described for a case where a plurality of speaker units are located between a driver's seat and an assistant driver's seat inside a vehicle or in the vicinity of a side wall of a vehicle body below rear seats. However, the invention is not specifically limited to this location of the speaker unit. Further, the vehicle is not limited to a car, and the invention is applicable to various movable bodies such as carriages.

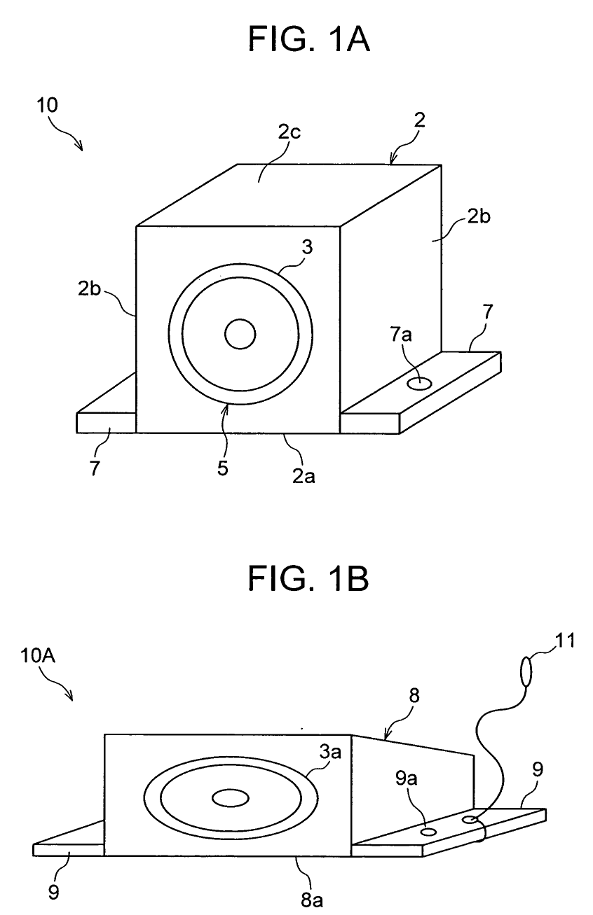

FIG. 1A shows a speaker unit according to Embodiment 1, and FIG. 1B shows Embodiment 2.

As shown in FIG. 1, the speaker unit 10 has an enclosure 2 and a speaker 5 attached to the enclosure 8.

The enclosure 2 has a bottom body 2a, side bodies 2b, 2b, 2b and 2b which are vertically located from the outer periphery of the bottom portion 2a, and a top body 2c for clogging up an upper portion of the side body, and formed to be in a box shape. The enclosure 2 is sealed so that inner air leaks to an outside.

Further, an opening 3 is provided in the side body in a forward direction. The speaker 5 is attached to the opening 3 so as to be in a close contact therewith.

Further, the enclosure 2 has an input and output terminal (not shown) for inputting an audio signal, and the input terminal is electrically connected to an input terminal of the speaker 5 inside the enclosure 2.

Further, support bodies 7,7 for fixing to a floor of the vehicle are provided on right and left sides of the bottom body 2a of the enclosure 2. The support bodies 7 have a penetrating hole 7a for attaching to the vehicle by a fastener such as a screw. Thus the enclosure 2 is firmly fixed to the floor of the vehicle by the fastener.

Further, as shown in FIG. 1B, an enclosure 8 of a speaker unit 10A may be in a shape that the side bodies gradually narrowed toward the back side of the enclosure 8. Further, the speaker 3a is attached to the enclosure 8 so that the size of the speaker 3a matches the enclosure 8. Further, a cord-like body 11 may be attached to support bodies 9, 9 which are located right and left of the bottom body 8a of the enclosure 8. The tip of the code-like body 11 is attached to a part of the vehicle body. The code-like body 11 may be made from any material as long as it has a sufficient strength to suspend the weight nearly of the enclosure. For example, it is appropriately selected from an ordinary used string or wire. Further, the enclosures 2, 8 are not limited to the sealed one shown in FIG. 1 and may be appropriately selected from, for example, a sealed type which allows small air leak, a damped bass-reflex type which is formed by an acoustic material is assembled into its port, and a and a bandpass type.

Further, speakers 3, 3a may be appropriately selected out of, for example, a corn type, a dome type and a horn type, and the size (the diameter and the mass) of the speakers is preferably small.

A reproducing signal of a predetermined frequency or less is inputted from a head unit (not shown) for reproducing a recording medium such as a compact disk (CD) or a digital versatile disc (DVD) to speakers 3, 3a. For example, a low pass filter may be installed between the head unit and the speakers 3, 3a. By this, the speakers 3, 3a can reproduce a reproduction signal under the predetermined frequency or less.

The shape and the inner volume of the enclosures 2, 8 are designed and formed such that minimum resonance frequency is lower than a predetermined frequency or less at a time of reproducing in a state that the speakers 3, 3a are attached to the enclosures 2, 8. Further, the minimum resonance frequency of the enclosures 2,8 including the speakers 3,3a (speaker unit 10) is preferably 200 Hz or less. As such, the speaker units 10, 10A may be mechanically reproduced. Further, a sufficient sound pressure is obtainable in sound ranges of mediant and bass in use of speaker units 10,10A having a low minimum resonance frequency.

Further, when the speaker units 10,10A are used as a sub woofer for reproducing a sound field by 5.1 ch surround sound system, a signal of the sub woofer by the 5.1 ch surround sound system is inputted into the speakers 3,3a.

Next, a position where the speaker unit is installed in the vehicle will be described.

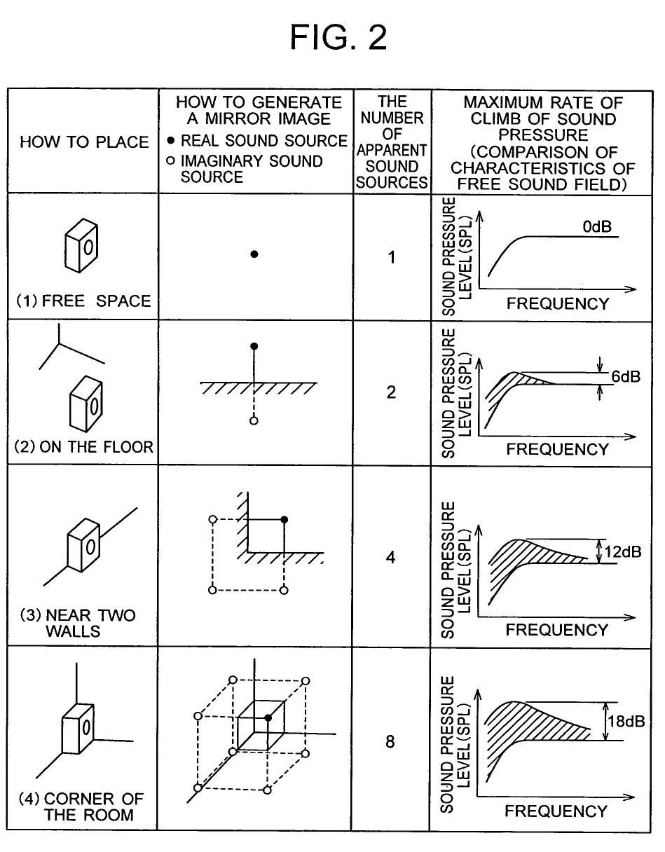

The speaker system for vehicle according to the present invention is formed by installing a plurality of speaker units 10,10A, which are formed by the speakers 3,3a attached to the enclosures 2,8 of a small size, in an inside of the vehicle in consideration of an imaginary sound source and the minimum resonance frequency is set low. The locations of the speakers and the imaginary sound source are explained in reference of FIG. 2. FIG. 2 shows a relation among the locations of the speakers, how to generate the imaginary sound source and a maximum degree of increase of sound pressure.

The position of the speaker unit is examined in use of a principle of mirror image. When the speaker is located on the floor surface at a position apart from the wall surfaces of the room space as shown in (2) of FIG. 2, an imaginary sound source exists in a direction opposite thereto through the real sound source and the floor surface. Therefore, there are apparently two sound sources. When these two sound sources are close to each other at a frequency of which wave length is sufficiently low enough in comparison with a distance between the sound sources, the emission impedance is doubled by a mutual interaction and the capability of the speaker is also doubled. Accordingly, the number of the sound sources of which capability are twice enhanced is two. Therefore, provided that the output power of sound of a speaker which is located in a free sound field is 1 W, the output power of sound of the above case becomes 4 W. Accordingly, the output power of sound which is reflected within a half space becomes 2 W. Further, the sound pressure level is higher than an anechoic chamber by 6 dB.

Further, when a speaker is located near the wall surface and the floor surface as shown in (3) of FIG. 2, the sound pressure is enhanced by 12 dB than an anechoic chamber. Further, as shown in (4) of FIG. 2, when a speaker is located in a corner in a chamber, the sound pressure level becomes 18 dB higher than that of the anechoic chamber.

Further, when the frequency is enhanced and therefore the distance between the sound sources are unignorable, the radiation impedance is lowered and the sound pressure level is also lowered. Further, at the frequency in which the distance between the sound sources becomes the half of the wavelength, a dip emerges. At a frequency higher than this, a peak and a dip alternatively emerge. Actually, in such a high frequency, the speaker has directional characteristics and the density of the principal vibration increases. Therefore, a prominent peak or dip does not emerge. Accordingly, a property close to that of the anechoic chamber is obtainable.

According to these, even a speaker having a small diameter can increase a sound pressure by providing the speaker at a position close to the floor or in the vicinity of the corner of the floor and the door, an imaginary sound source is formed and a sound pressure increases.

Further, it is known that sound pressure characteristics of a sound pressure in an air chamber which is sealed or hermetically closed becomes flat in a region of stiffness control of the resonance frequency or less of the sealed type speaker system.

Thus it is possible to acquire a sound pressure which is practically low enough by providing a plurality of speaker units to which small size speakers are attached to small sized enclosures assuring a vibration area to thereby assure a vibration area. Further, since the internal space of the vehicle is narrow enough to install a large enclosure. Therefore, a predetermined sound pressure is obtainable by installing a plurality of small-sized enclosures. Further, by making the enclosures small, it is possible to install the enclosures on a floor of the vehicle, under seats or at corners in the vicinity of the floor, the seats and rear seats.

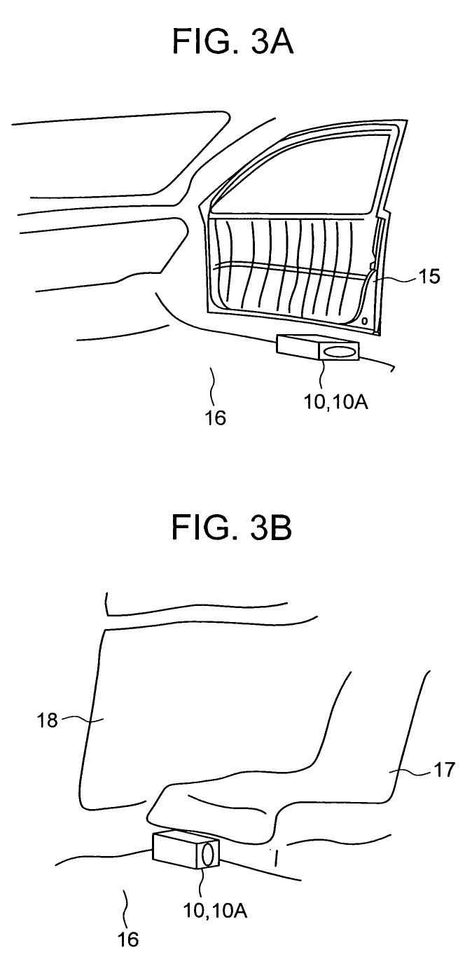

FIGS. 3A and 3B show an example of installing a speaker unit. FIG. 3A is about Embodiment 1, and FIG. 3B is about Embodiment 1. The speaker units 10, 10A are preferably attached to in the vicinity of the door 15 for getting on and off, a corner near the floor surface 16, below the seats 17, at corners in the vicinity of the seats 17, the floor surface 16 and the door 18 for getting on and off.

Further, when the attached positions of the speakers are high, the speakers are in the way and the effect of the imaginary sound is weakened. Therefore, it is preferable to attach the speaker at a position as close as possible to the floor surfaces. Further, the baffle effect is better obtained as the attaching position of the speaker is closer to the floor surface. Further, it is possible to effectively acquire this effect of the imaginary sound source and the baffle effect at positions of about 20 cm or less from the floor surface. Further, if the position is near the corners, the effect of the imaginary sound source and the baffle effect are further improved. Further, as described in the above, a sound pressure inside a chamber of a small capacity such as a vehicle, it is possible to make the sound pressure in a low range high in comparison with an free space. Accordingly, it is possible to acquire a high sound pressure level in a middle low range of smaller when the attaching position of the speaker is within about 20 cm from the floor surface and the speaker unit is located in the vicinity of the corners.

Further, in the small sized enclosure, mediant and bass of a good quality are obtainable because a radiation of sound from the enclosure itself is small. Further, since the speaker unit is located inside the vehicle in a form of a separate body, it is possible to reduce a leakage of sound to the outside.

As described above, according to this embodiment, the speaker system according to the present invention, the speaker system to be used in a cabin according to the present invention is formed by locating a plurality of the speaker units 10, which are obtained by attaching the speaker 3 to the small-sized enclosure 2, in consideration of the imaginary sound source and the minimum resonance frequency of the speaker unit 10 is set to be low. Specifically, the speaker unit 10 is set up such that the resonance frequency is 200 Hz or less, the height of the speaker unit is 20 cm or less from the floor surface inside the vehicle, and the inner capacity of the enclosure 2 is 1000 cc or less.

As such, not only the effect of the imaginary sound source and the baffle effect are effectively obtainable but also the high sound pressure level is obtainable even though the speaker unit 10 is small in accordance with a principle of mirror image. Further, it is possible to locate a speaker unit at a position where an effect of an imaginary sound source is easily obtainable in use of the small sized enclosure.

Further, it is possible to input a signal of a predetermined frequency or less to all of the speakers 3. Further, it is possible to make the speaker unit 10 mechanically reproduce a predetermined frequency or less.

Further, the enclosure 2 is appropriately selected out of a sealed type, a sealed type of allowing minute air leakage, a damped bass-reflex alignment type in which an acoustic material is assembled inside a port, and a band pass type.

Further, a signal may be inputted into all speakers of a speaker system for a vehicular cabin so that arrival times respectively from the speakers are adjusted to match each other. Further, a reach time adjusting means may be provided for electrically adjusting the arrival times of sounds from each of the speakers.

Accordingly, the sounds which are outputted from the plurality of speakers and of which arrival times match can be reproduced.

Further, a signal of a sub woofer in a 5.1 ch surround sound system may be inputted into all of speakers of the speaker system for vehicular cabin. As such, the speaker unit can be used as the sub woofer of the 5.1 ch surround sound system.

Further, the enclosure 2,8 may have holes 7a, 9a for fixing to a vehicular body. A cord-like body 11 for fixing to the vehicle body may be attached to the enclosure 8. As such, the enclosures 2,8 can be firmly fixed to the vehiclar body.

The present invention is not confined to the configurations listed in the foregoing embodiments, but it is easily understood that the person skilled in the art can modify such configurations into various other modes, within the scope of the present invention described in the claims.

The entire disclosures of Japanese Patent Applications No. 2004-180938 filed on Jun. 18, 2004 including the specification, claims, drawings and summary are incorporated herein by reference in its entirety.

What is claimed is:

1. A speaker system for a vehicle comprising:
a plurality of speaker units which are formed by attaching a speaker to an enclosure and located inside the vehicle, wherein
an imaginary sound source is considered in arranging the speaker units inside the vehicle and the minimum resonance frequency of the speaker units is reduced.

2. The speaker system according to claim 1, wherein
the minimum resonance frequency of the speaker unit is 200 Hz or less,
the speaker unit is located at the height 20 cm or less from the floor surface inside the vehicle, and
the inner capacity of the enclosure is 1000 cc or less.

3. The speaker system according to claim 1, wherein
a signal of a predetermined frequency or less is inputted into all of the speakers.

4. The speaker system according to claim 2, wherein
a signal of a predetermined frequency or less is inputted into all of the speakers.

5. The speaker system according to claim 1, wherein
the speaker unit mechanically reproduces a predetermined frequency or less.

6. The speaker system according to claim 2, wherein
the speaker unit mechanically reproduces a predetermined frequency or less.

7. The speaker system according to claim 1, wherein
the enclosure is of any one of a sealed type, a sealed type of allowing minute air leakage, a damped bass-reflex alignment type in which an acoustic material is assembled inside a port, and a band pass type.

8. The speaker system according to claim 2, wherein
the enclosure is of any one of a sealed type, a sealed type of allowing minute air leakage, a damped bass-reflex alignment type in which an acoustic material is assembled inside a port, and a band pass type.

9. The speaker system according to claim 1, wherein
a signal adjusted to match arrival times respectively from the speakers to an audience position is inputted into all the speakers.

10. The speaker system according to claim 2, wherein
a signal adjusted to match arrival times respectively from the speakers to an audience position is inputted into all the speakers.

11. The speaker system according to claim 1, further comprising:
an arrival time adjusting means for electrically adjusting the arrival times respectively from the speakers to the audience position.

12. The speaker system according to claim 2, further comprising:
an arrival time adjusting means for electrically adjusting the arrival times respectively from the speakers to the audience position.

13. The speaker system according to claim 1, wherein
a signal of a sub woofer in a 5.1 ch surround sound system is inputted to all the speakers.

14. The speaker system according to claim 2, wherein
a signal of a sub woofer in a 5.1 ch surround sound system is inputted to all the speakers.
